(19) United States
(12) Patent Application Publication
(10) Pub. No.: US 2022/0172043 A1
(43) Pub. Date: Jun. 2, 2022

(54) ADJUSTABLE DEEP LEARNING COMPRESSION BY HIERARCHICAL DELTA-WEIGHT SHARING

(71) Applicant: International Business Machines Corporation, Armonk, NY (US)

(72) Inventors: Su LIU, Austin, TX (US); Jinho LEE, Austin, TX (US); Inseok HWANG, Austin, TX (US); Matthew Harrison TONG, Austin, TX (US)

(21) Appl. No.: 17/108,670

(22) Filed: Dec. 1, 2020

(51) Int. Cl. G06N 3/08; G06N 3/04

(52) U.S. Cl. CPC G06N 3/08; G06N 3/04

(57) ABSTRACT

A method includes clustering a plurality of weights of a neural network model into a first plurality of clusters and clustering differences between (i) the plurality of weights assigned to a first cluster of the first plurality of clusters and (ii) a centroid value of the first cluster into a second plurality of clusters. The method also includes storing, in a first table, an identifier and a centroid value for each cluster of the second plurality of clusters and for each of the plurality of weights assigned to the first cluster, storing, in a second table, an identifier of a respective cluster of the second plurality of clusters corresponding to that weight.

### BACKGROUND

The present invention relates to machine learning, and more specifically, to the storage and loading of weights for a machine learning model (e.g., a neural network model).

### SUMMARY

According to one embodiment, a method includes clustering a plurality of weights of a neural network model into a first plurality of clusters and clustering differences between (i) of the plurality of weights assigned to a first cluster of the first plurality of clusters and (ii) a centroid value of the first cluster into a second plurality of clusters. The method also includes storing, in a first table, an identifier and a centroid value for each cluster of the second plurality of clusters and for each of the plurality of weights assigned to the first cluster, storing, in a second table, an identifier of a respective cluster of the second plurality of clusters corresponding to that weight. Another embodiment includes an apparatus that includes a memory and a hardware processor configured to perform this method.

According to another embodiment, the method may also include determining that a first weight of the plurality of weights is assigned to the first cluster and, based on the second table, that the first weight corresponds to a second cluster of the second plurality of clusters and in response to determining that the first weight is assigned to the first cluster and that the first weight corresponds to the second cluster, adding the centroid value of the first cluster to a centroid value of the second cluster to produce an estimated weight. The method may also include making a prediction, using the neural network model, by applying the estimated weight.

### BRIEF DESCRIPTION OF THE SEVERAL VIEWS OF THE DRAWINGS

FIG. 1 illustrates an example system;

FIG. 2 illustrates generating first tier weights using the system of FIG. 1;

FIG. 3 illustrates generating second tier weights using the system of FIG. 1;

FIG. 4 illustrates generating second tier weights using the system of FIG. 1;

FIG. 5 illustrates generating third tier weights using the system of FIG. 1; and

FIG. 6 is a flowchart of a method for determining estimated weights using the system of FIG. 1.

### DETAILED DESCRIPTION

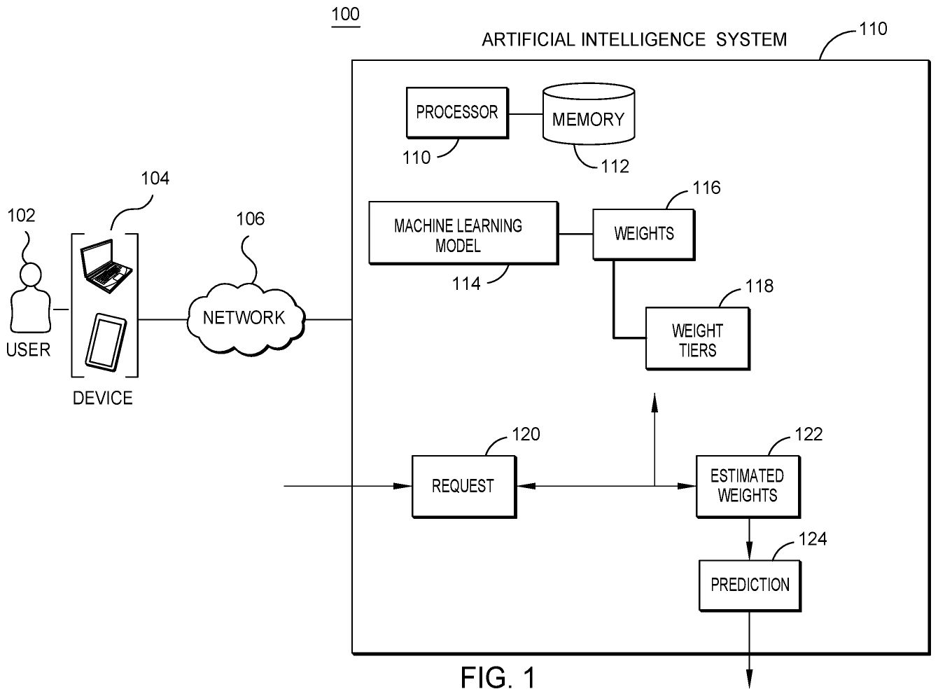

Machine learning models (e.g., neural network models) are typically designed to apply a series of weights to received information to make predictions based on that weighted data. Larger models with more weights can be trained (given sufficient data) to be more accurate. However, the additional weights result in the machine learning model using additional computing resources (e.g., processing resources, memory resources, storage resources, or network resources). When these computing resources are not available, the machine learning model may not function. This disclosure contemplates a machine learning model (e.g., a neural network model) that can generate and load a different number of tiers of weights depending on the amount of available computing resources. Each tier clusters weights into encoded values, with the first tier capturing most of the variance of the weights, and each successive tier addressing more of the residual error from the actual weights. When more computing resources are available, the machine learning model can load more tiers of weights to improve weight accuracy. When fewer computing resources are available, the machine learning model can load fewer tiers of weights to avoid consuming all the computing resources. The machine learning model will be discussed in more detail with respect to FIGS. 1 through 6.

With reference now to FIG. 1, which illustrates an example system 100. As seen in FIG. 1, system 100 includes one or more devices 104, a network 106, and an artificial intelligence system 108. Generally, the system 100 generates tiers of weights for a machine learning model (e.g., a neural network model) used by the artificial intelligence system 108. Different tiers of weights may be loaded and used by the machine learning model based on the computing resources available to the machine learning model. In this manner, the machine learning model loads an amount of information suitable for the computing resources that are available to the machine learning model in certain embodiments.

A user 102 may use one or more device 104 to communicate with other components of the system 100. For example, the user 102 may use the device 104 to communicate instructions or commands to the artificial intelligence system 108. As another example, the device 104 may receive predictions from the artificial intelligence system 108. The device 104 includes any suitable device for communicating with components of system 100 over the network 106. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may also include a user interface, such as a display, a microphone, keypad, or other appropriate terminal equipment usable by the user 102. The device 104 may include a hardware processor, memory, or circuitry configured to perform any of the functions or actions of the device 104 described herein. For example, a software application designed using software code may be stored in the memory and executed by the processor to perform the functions of the device 104.

The network 106 is any suitable network operable to facilitate communication between the components of the system 100. The network 106 may include any interconnecting system capable of transmitting audio, video, signals, data, messages, or any combination of the preceding. The network 106 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

The artificial intelligence system 108 implements and maintains a machine learning model (e.g., a neural network model) that the artificial intelligence system 108 uses to make predictions. As seen in FIG. 1, the artificial intelligence system 108 includes a processor 110 and a memory 112, which are configured to perform any of the functions or features of the artificial intelligence system 108 described herein. The artificial intelligence system 108 may include any suitable number of processors 110 and memories 112, including processor 110 and memories 112 implemented across several devices in a distributed architecture. In particular embodiments, the artificial intelligence system 108 loads and uses different amounts of information to make predictions depending on the amount of computing resources available to the artificial intelligence system 108.

The processor 110 is any electronic circuitry, including, but not limited to microprocessors, application specific integrated circuits (ASIC), application specific instruction set processor (ASIP), and/or state machines, that communicatively couples to memory 112 and controls the operation of the artificial intelligence system 108. The processor 110 may be 8-bit, 16-bit, 32-bit, 64-bit or of any other suitable architecture. The processor 110 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 110 may include other hardware that operates software to control and process information. The processor 110 executes software stored on memory to perform any of the functions described herein. The processor 110 controls the operation and administration of the artificial intelligence system 108 by processing information (e.g., information received from the devices 104, network 106, and memory 112). The processor 110 may be a programmable logic device, a microcontroller, a microprocessor, any suitable processing device, or any suitable combination of the preceding. The processor 110 is not limited to a single processing device and may encompass multiple processing devices.

The memory 112 may store, either permanently or temporarily, data, operational software, or other information for the processor 110. The memory 112 may include any one or a combination of volatile or non-volatile local or remote devices suitable for storing information. For example, the memory 112 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 112, a disk, a CD, or a flash drive. In particular embodiments, the software may include an application executable by the processor 110 to perform one or more of the functions described herein.

The artificial intelligence system 108 implements and maintains a machine learning model 114. The machine learning model 114 may be any suitable model that can be used to make predictions based on provided data. For example, the machine learning model 114 may be a neural network model. The artificial intelligence system 108 trains the machine learning model 114 to make predictions based on provided information. For example, the artificial intelligence system 108 may use the machine learning model 114 to predict machine behavior, human behavior, economic movement, etc. based on data provided to the artificial intelligence system 108 and the machine learning model 114.

The machine learning model 114 applies weights 116 to data or information to make predictions. Generally, the weights 116 are numerical values that may be applied to different facets of the data to produce scores that the machine learning model 114 uses to make its predictions. Typically, the accuracy of the predictions is influenced by the number of weights 116 applied by the machine learning model 114. The more weights 116 that are applied, the more facets of the information that the machine learning model 114 analyzes to generate its predictions, and the more accurate the predictions are expected to be. The artificial intelligence system 108 trains the machine learning model 114 to make predictions by adjusting the weights 116 to hone the performance of the machine learning model 114. For example, the machine learning model 114 may apply the weights 116 to training data to make test predictions. Based on the accuracy of the test predictions, the artificial intelligence system 108 may adjust the weights 116 to improve the accuracy of the machine learning model 114.

As the number of weights 116 increases, the amount of computing resources needed to store, load, and process the weights 116 also increases. As a result, improving the accuracy of the machine learning model 114 may result in additional computing resources being needed to store, load, and process the weights 116, which may reduce the portability of the machine learning model 114. For example, if the machine learning model 114 was trained using a first artificial intelligence system 108 with a first amount of computing resources (e.g., processor, memory, or network resources), then it may be difficult to port or transfer the machine learning model 114 to a second artificial intelligence system 108 that has fewer computing resources available. As a result, the second artificial intelligence system 108 may not have sufficient computing resources to store, load, or process the weights 116 of the machine learning model 114, and the machine learning model 114 may become unusable.

The artificial intelligence system 108 may generate tiers 118 of weights for the machine learning model 114. Generally, different tiers 118 of weights may be stored or loaded depending on the amount of computing resources available in the artificial intelligence system 108. As a result, when the artificial intelligence system 108 experiences a reduced amount of computing resources, the artificial intelligence system 108 may store or load fewer tiers 118 of weights for the machine learning model 114, in certain embodiments. The machine learning model 114 can still use the stored or loaded tiers 118 of weights to make accurate predictions corresponding to the amount of computing resources available in the artificial intelligence system 108.

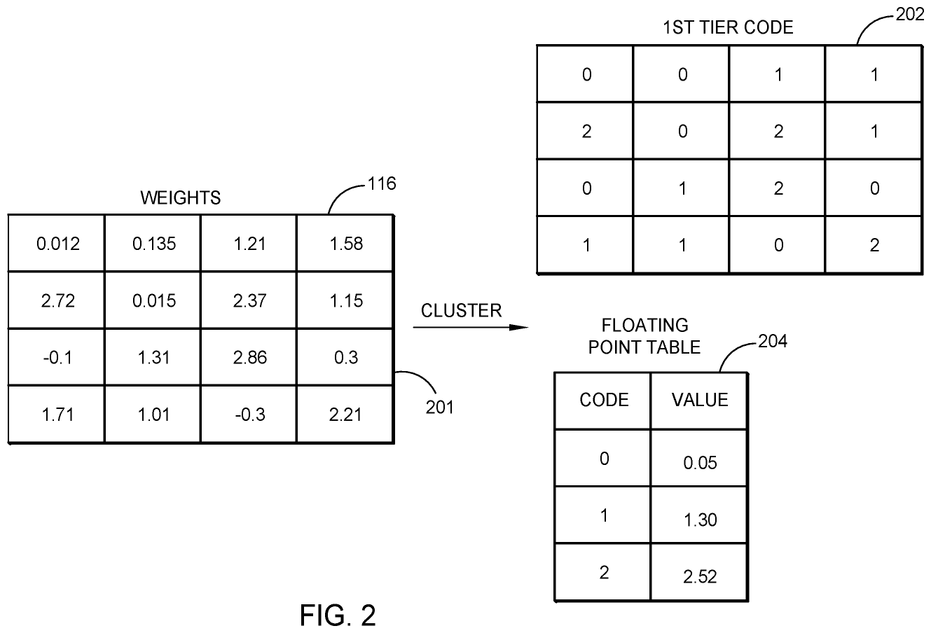

The artificial intelligence system 108 generates weight tiers 118 based on the weights 116. Generally, the artificial intelligence system 108 generates the weight tiers 118 by clustering the weights 116 to create a first tier 118. The artificial intelligence system 108 may then generate subsequent tiers 118 by determining differences or deltas between the values of the weights 116 and the centroids of the clusters to which the weights 116 are assigned. The artificial intelligence system 108 may then cluster these differences or deltas to create subsequent tiers 118. Additional details for generating and using weight tiers 118 will be provided with respect to FIGS. 2 through 6.

The artificial intelligence system 108 may receive a request 120 to apply a particular weight of the weights 116. For example, the request 120 may be communicated by a user 102 using the device 104. The request 120 may instruct the artificial intelligence system 108 to make a prediction based on provided information or data (e.g., information provided in the request 120). The artificial intelligence system 108 may determine from the request 120 that a particular weight of the weights 116 should be applied by the machine learning model 114 to make the requested prediction.

In response to the request 120, the artificial intelligence system 108 may generate estimated weights 122 based on the weight tiers 118. The artificial intelligence system 108 may load a suitable number of tiers 118 of weight based on the request 120 or the amount of available computing resources in the artificial intelligence system 108. For example, the artificial intelligence system 108 may determine that the memory 112 includes a sufficient amount of memory to load a certain number of tiers 118 of weight. In response, the artificial intelligence system 108 may load a number of tiers 118 of weights that can be handled by the amount of available memory 112. As another example, the artificial intelligence system 108 may have loaded a certain number of tiers 118. The request 120 may request an improvement in the accuracy of the machine learning model 114. In response, the artificial intelligence system 108 may load additional tiers 118 into the memory 112. As a result of loading additional tiers of weight tiers 118, the accuracy of the machine learning model 114 is expected to improve. The artificial intelligence system 108 may generate the estimated weights 122 based on the weight tiers 118 that have been loaded. Generally, the artificial intelligence system 108 may apply the differences or deltas in the loaded weight tiers 118 to the centroid values of the clusters of the loaded weight tiers 118 to generate the estimated weights 122. Additional details for the generation of the estimated weights 122 are provided with respect to FIGS. 2 through 6.

The artificial intelligence system 108 uses the estimated weights 122 to make a prediction 124. The prediction 124 may be requested by the request 120. After generating the prediction 124, the artificial intelligence system 108 communicates the prediction 124 to the device 104 to respond to the request 120. The prediction 124 may be any suitable type of prediction such as for example, a prediction of machine behavior, human behavior, economic behavior, etc.

FIG. 2 illustrates generating first tier weights using the system 100 of FIG. 1. Generally, the artificial intelligence system 108 clusters the weights 116 based on the values of those weights 116 to generate the first tier weights. In particular embodiments, storing the first tier weights take up less space in the memory 112 than storing the weights 116. As a result, if the artificial intelligence system 108 loads the first tier weights to generate the estimated weights 122, then the artificial intelligence system 108 uses less memory and processing resources to store, load, and process the first tier weights relative to the weights 116.

In the example of FIG. 2, the artificial intelligence system 108 clusters the weights 116 based on the values of the weights 116. The artificial intelligence system 108 may cluster the weights 116 into any suitable number of clusters. In the example of FIG. 2, the artificial intelligence system 108 clusters the weights 116 into three different clusters based on the values of those weights 116. As a result, the weights 116 that are assigned to a cluster will have similar values.

The artificial intelligence system 108 generates first tier codes that identify the clusters to which the weights 116 are assigned. The weights 116 are arranged in a table 201. Each first tier code may be stored in a table 202 as a 2-bit value, as opposed to a floating point value for storing the weights 116. As a result, the first tier codes occupy less space in the memory 112 than the weights 116. The location in the table 202 of the first tier code for a weight 116 corresponds to a location of that weight 116 in the table 201. In the example of FIG. 2, six weights are assigned to a cluster identified with the first tier code of 0. These weights 116 have values of 0.012, 0.135, 0.15, −0.1, 0.3, and −0.3. Additionally, six weights 116 are assigned to a cluster identified by a first tier code of 1. These weights 116 have values of 1.21, 1.58, 1.15, 1.31, 1.71, and 1.01. Furthermore, four weights 116 are assigned to a cluster identified by a first tier code of 2. These weights 116 have values of 2.72, 2.37, 2.86, and 2.21.

The artificial intelligence system 108 also stores the centroid values of the clusters. The centroid values may be averages of the values of the weights 116 assigned to those clusters. In the example of FIG. 2, the cluster with the first tier code of 0 has a centroid value of 0.05. Additionally, the cluster with the first tier code 1 has a centroid value of 1.30. Moreover, the cluster identified by the first tier code 2 has a centroid value 2.52. The artificial intelligence system 108 stores these centroid values along with their corresponding first tier codes in a table 204. The centroid values are stored as floating point values.

If the artificial intelligence system 108 stores or loads the tables 202 and 204, rather than the weights 116, then the artificial intelligence system 108 may use less memory resources. In the example of FIG. 2, by storing or loading the tables 202 and 204, the artificial intelligence system 108 would store or load sixteen 2-bit values and three floating point values, as opposed to sixteen floating point values if the weights 116 had instead been stored or loaded. When the artificial intelligence system 108 is requested to apply a particular weight 116, the artificial intelligence 108 may use the table 202 to identify the cluster to which that weight 116 is assigned. The artificial intelligence system 108 then uses the table 204 to determine the centroid value of that cluster. The artificial intelligence system 108 then uses the centroid value as the estimated weight 122. The artificial intelligence system 108 applies that estimated weight rather than the requested weight 116 in making its prediction 124. Because the centroid value is not the same as the value of the requested weight 116, the accuracy of the artificial intelligence system 108 is expected to decrease. The artificial intelligence system may generate and apply additional tiers 118 of weights to improve the accuracy of the artificial intelligence system 108, in certain embodiments.

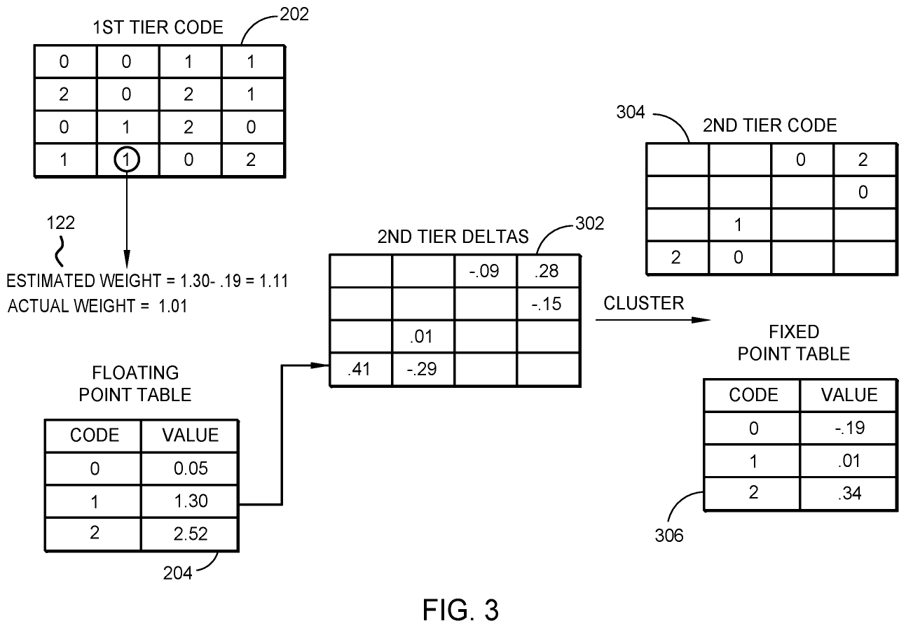

FIG. 3 illustrates generating second tier weights using the system 100 of FIG. 1. Generally, the artificial intelligence system 108 generates the second tier of weights using differences between the values of the weights 116 and the centroid values of the clusters to which those weights 116 are assigned. In particular embodiments, storing, loading, or processing the second tier weights improves the accuracy of the artificial intelligence system 108 or the machine learning model 114, relative to storing, loading, and processing only the first tier weights.

The artificial intelligence system 108 generates the second tier weights by first calculating the differences or deltas between the values of the weights 116 assigned to a cluster and the centroid value of that cluster. In the example of FIG. 3, the artificial intelligence system 108 calculates the second tier weights for the weights 116 assigned to the cluster identified by the first tier code 1. The artificial intelligence system 108 first subtracts the values of the weights 116 assigned to that cluster to generate the second tier deltas for these weights 116. The second tier deltas include the values −0.09, 0.28, −0.15, 0.01, 0.41, and −0.29. The artificial intelligence system 108 may store the second tier deltas in a table 302. The locations of the second tier deltas in the table 302 correspond to the locations of the first tier codes for those weights 116 in the table 202.

After determining the second tier deltas, the artificial intelligence system 108 clusters these second tier deltas. The artificial intelligence system 108 may cluster the second tier deltas into any suitable number of clusters. In the example of FIG. 3, the artificial intelligence system 108 clusters the second tier deltas into three different clusters. The second tier deltas assigned to a cluster should have similar values. These clusters are each identified by a 2-bit second tier code. The artificial intelligence system 108 stores the second tier codes in a table 304. The locations of the second tier codes in the table 304 correspond to the locations of the first tier codes for the weights 116 in the table 202. In the example of FIG. 3, the second tier deltas with the values −0.09, −0.15, and −0.29 are assigned to a cluster identified by the second tier code 0. Additionally, the second tier delta with the value 0.01 is assigned to a cluster identified by the second tier code 1. Moreover, the second tier deltas with the values 0.41 and 0.28 are assigned to a cluster identified by the second tier code 2.

The artificial intelligence system 108 determines the centroid values for the clusters. In certain embodiments, the centroid values for the clusters may be an average of the second tier deltas assigned to those clusters. The artificial intelligence system 108 stores the centroid values for the clusters along with their corresponding identifying second tier code in a table 306. The centroid values may be stored as fixed point values in the table 306. In the example of FIG. 3, the cluster identified by the second tier code 0 has a centroid value of −0.19. Additionally, the cluster identified by the second tier code 1 has a centroid value of 0.01. Moreover, the cluster identified by the second tier code 2 has a centroid value 0.34.

The artificial intelligence system 108 may store or load the tables 202 and 204 and the tables 304 and 306 to improve the accuracy of the artificial intelligence system 108, in certain embodiments. When the tables 202, 204, 304, and 306 are stored or loaded, the artificial intelligence system 108 may use these tables 202, 204, 304, and 306 to make predictions 124. For example, if the artificial intelligence system 108 receives a request to apply a weight 116, then the artificial intelligence system 108 may determine the centroid value of the first tier cluster to which that weight 116 is assigned. The artificial intelligence system 108 may then determine the centroid value of the second tier cluster to which that weight 116 is assigned. The artificial intelligence system 108 may then add the two centroid values to generate the estimated weight 122.

In the example of FIG. 3, the request 120 requests the artificial intelligence system 108 to apply the weight 116 with the value 1.01. In response, the artificial intelligence system 108 determines from the table 202 that the requested weight 116 is assigned to the cluster identified by the first tier code 1. The artificial intelligence system 108 then determines from the table 204 that the cluster has a centroid value 1.30. The artificial intelligence system 108 then determines from the table 304 that the requested weight 116 is assigned to a cluster identified by the second tier code 0. The artificial intelligence system 108 then determines from table 306 that the cluster identified by the second tier code 0 has a centroid value of −0.19. The artificial intelligence system 108 then adds the first tier cluster centroid value 1.30 to the second tier cluster centroid value −0.19 to produce the estimated weight 122 with the value 1.11. As seen in FIG. 3, 1.11 is closer to the actual weight 1.01 than the centroid value (1.30) of the cluster identified with the first tier code 1. As a result, by storing or loading the tables 304 and 306 and applying the centroid values of the clusters identified by the second tier codes, the artificial intelligence system 108 improves the accuracy of the machine learning model 114.

As discussed previously, the artificial intelligence system 108 may store, load, or process any suitable number of tiers 118 of weights based on the request 120 or the amount of available computing resources. For example, the artificial intelligence system 108 may determine that there are sufficient computing resources available to load and process two tiers 118 of weights. In response, the artificial intelligence system may load the tables 202, 204, 304, and 306 and determine the estimated weights 122 using the process shown in FIG. 3. As another example, the artificial intelligence system 108 may determine that there are sufficient computing resources available to load and process only one tier 118 of weights. In response, the artificial intelligence system may load the tables 202 and 204 and determine the estimated weights 122 as discussed with respect to FIG. 2. As yet another example, the artificial intelligence system 108 may have loaded the tables 202 and 204, and the request 120 may request improved accuracy. In response, the artificial intelligence system 108 may load the tables 304 and 306 in addition to the tables 202 and 204 and determine the estimated weights 122 using the process shown in FIG. 3 to improve accuracy.

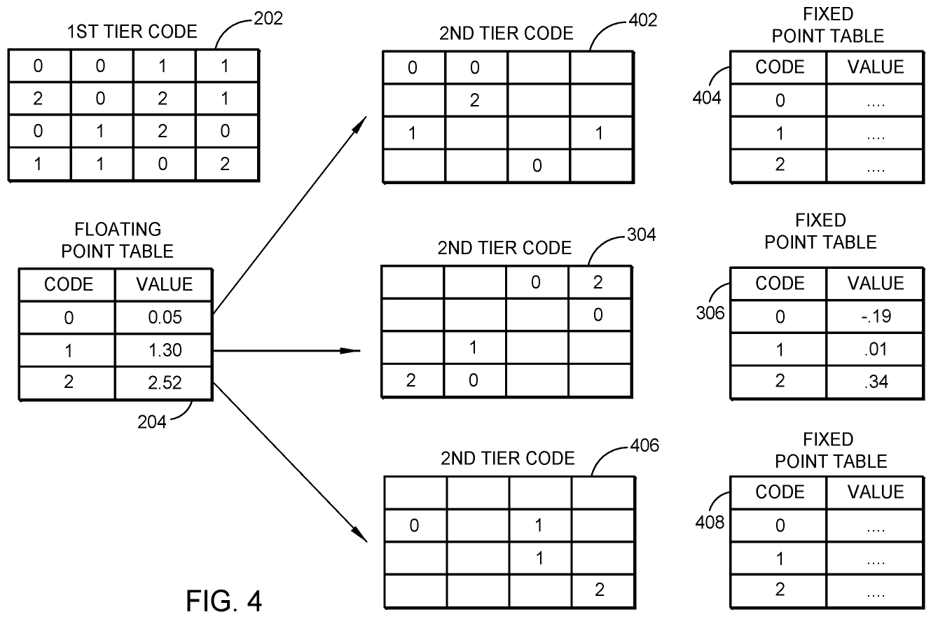

FIG. 4 illustrates generating second tier weights using the system 100 of FIG. 1. Generally, the artificial intelligence system 108 may follow the process shown in FIG. 3 to assign every weight 116 to a cluster identified by a second tier code. In this manner, the artificial intelligence system 108 may improve the accuracy of the machine learning model 114 for each requested weight 116, in certain embodiments.

The example of FIG. 3 showed generating second tier codes and centroid values of clusters for second tier deltas of weights 116 assigned to a cluster identified by the first tier code 1. This process can be repeated for weights 116 assigned to a cluster identified by other first tier codes. As seen in FIG. 4 the artificial intelligence system 108 generates differences or deltas and then clusters those differences or deltas for every cluster identified by a first tier code. In this manner, every cluster identified by a first tier code has a corresponding set of second tier codes and centroid values. For example, the artificial intelligence system 108 calculates differences or deltas for the weights 116 assigned to the first tier cluster identified by the first tier code 0. The artificial intelligence system 108 then clusters these differences or deltas into second tier clusters identified by second tier codes. The artificial intelligence system 108 also calculates centroid values for these second tier clusters. The artificial intelligence system 108 stores the second tier codes for these clusters in a table 402, and the centroid values for these clusters in a table 404. Additionally, the artificial intelligence system 108 determines differences or deltas for the weights 116 assigned to the first tier cluster identified by the first tier code 2. The artificial intelligence system 108 then clusters these differences or deltas into second tier clusters identified by second tier codes. The artificial intelligence system 108 also determines centroid values for these second tier clusters. The artificial intelligence system 108 stores the second tier codes in the table 406 and the centroid values in the table 408.

The artificial intelligence system 108 may store, load or process the tables 202, 204, 402, 404, 304, 306, 406, and 408 to apply two tiers of clusters for requested weights. For example, when the request 120 requests that a particular weight 116 be applied, the artificial intelligence system 108 may refer to tables 202 and 204 and a corresponding set of second tier tables, 402 and 404, 304 and 306, or 406 and 408 to generate an estimated weight 122 for the requested weight 116. In particular embodiments, by applying the first tier clusters and the second tier clusters to produce the estimated weights 122. The artificial intelligence system 108 improves the accuracy of the machine learning model 114 relative to applying only the first tier of clusters.

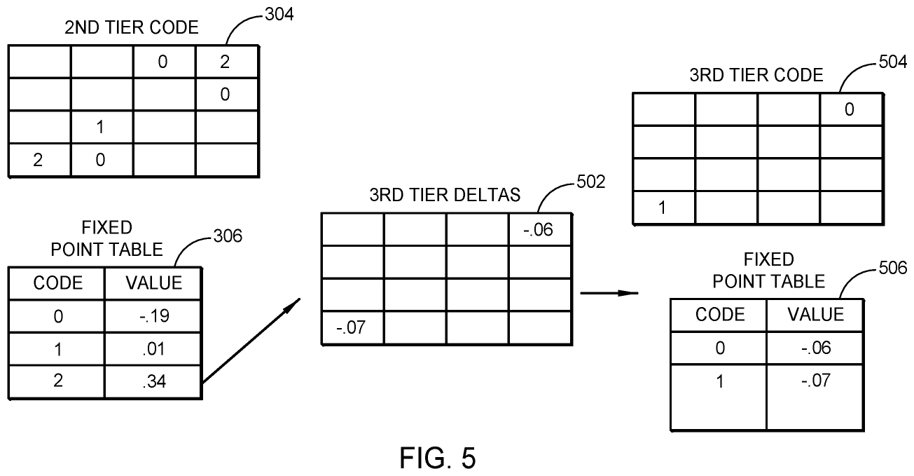

FIG. 5 illustrates generating third tier weights using the system 100 of FIG. 1. As discussed previously, the artificial intelligence system 108 may generate any suitable number of weight tiers 118 based on the weights 116. Each tier 118 provides an extra layer of customizability for the artificial intelligence system 108 and the machine learning model 114. For example, the artificial intelligence system 108 may store, load, or process any number of tiers 118 based on the computing resources available to the artificial intelligence system 108. The more tiers 118 that the artificial intelligence system 108 uses to generate the estimated weights 122, the more accurately the machine learning model 114 makes predictions 124 using those estimated weights 122, in particular embodiments.

In the example of FIG. 5, the artificial intelligence system 108 generates third tier weights based on the second tier clusters shown in FIGS. 3 and 4. The artificial intelligence system 108 generates third tier deltas by determining differences between the second tier deltas in the table 302 and the centroid value for the cluster to which that second tier delta is assigned. The artificial intelligence system 108 stores the third tier deltas into corresponding locations in a table 502. The artificial intelligence system 108 then clusters the third tier deltas into clusters. The artificial intelligence system 108 identifies these clusters using third tier codes. The artificial intelligence system 108 stores the third tier codes into corresponding locations in a table 504. The artificial intelligence system 108 also determines a centroid value for each of these clusters. The centroid values may be averages of the third tier deltas assigned to those clusters. The artificial intelligence system 108 stores the centroid values for the clusters and the third tier codes that identify these clusters in a table 506. The artificial intelligence system may perform this process for each cluster identified by a second tier code. Using the example from FIG. 4, the nine clusters identified by second tier codes would each have corresponding third tier codes and centroid values.

In the example of FIG. 5, the artificial intelligence system 108 determines third tier deltas for the second tier deltas assigned to the cluster identified by the second tier code 2. The artificial intelligence system 108 determines a difference between the second tier deltas and the centroid value for the cluster identified by the second tier code 2. As shown previously, these second tier deltas have the values 0.41 and 0.28, and the centroid value is 0.34. The third tier deltas have the values 0.07 and −0.06. The artificial intelligence system 108 clusters these third tier deltas into respective clusters identified by the third tier codes 0 and 1. Because these clusters include only one third tier delta each, the centroid values for these clusters are the values of the third tier deltas. The cluster identified by the third tier code 0 has a centroid value of −0.06. The cluster identified by the third tier code 1 has a centroid value of 0.07. The artificial intelligence system 108 stores the third tier deltas into corresponding locations of the table 502, the third tier codes into corresponding locations of the table 504, and the centroid values and the third tier codes for the clusters into the table 506. The third tier codes may be stored as 2-bit values in the table 504. The centroid values may be stored as fixed point values in the table 506.

The artificial intelligence system 108 may follow the process or pattern shown in FIGS. 2 through 5 to generate any suitable number of tiers 118. The artificial intelligence system 108 may then store, load, or process any suitable number of tiers 118 depending on the amount of computing resources available to the artificial intelligence system 108. In particular embodiments, the more tiers that are used to generate the estimated weights 122, the more accurate the machine learning model 114 performs. In this manner, the artificial intelligence system 108 adjusts the accuracy of the machine learning model 114 based on the amount of available computing resources.

The artificial intelligence system 108 may generate estimated weights 122 using the first tier, second tier, and third tier clusters. For example, the artificial intelligence system 108 may generate the estimated weight 122 according to the process shown in FIG. 3. Then the artificial intelligence system 108 may use table 504 to determine a cluster corresponding to the requested weight 116 and table 506 to determine the centroid value of that cluster. The artificial intelligence system 108 may then add that centroid value to the estimated weight 122 determined in FIG. 3. This process may be repeated for any number of tiers 118 to produce the estimated weight 122.

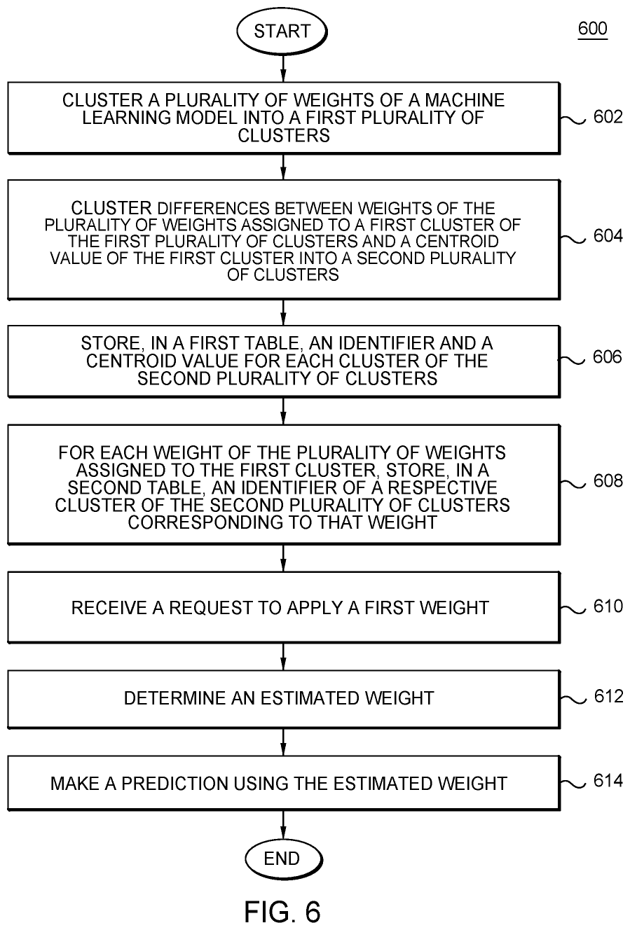

FIG. 6 is a flowchart of a method 600 for determining the estimated weights 122 using the system 100 of FIG. 1. Generally, the artificial intelligence system 108 performs the steps of the method 600. In particular embodiments, the artificial intelligence system 108 stores, loads, or processes a different number of tiers 118 to produce the estimated weight 122, depending on the amount of computing resources available to the artificial intelligence system 108. In this manner, the artificial intelligence system 108 is able to make predictions 124 using the machine learning model 114, even when the amount of computing resources available to the artificial intelligence system 108 is different than the amount of computing resources available the machine learning model 114 was trained.

In step 602, the artificial intelligence system 108 clusters a plurality of weights 116 of a machine learning model 114 into a first plurality of clusters. These clusters may be identified by first tier codes stored in a table 202. In step 604, the artificial intelligence system 108 clusters differences between the weights 116 of the plurality of weights 116 assigned to a first cluster of the first plurality of clusters and a centroid value of the first cluster into a second plurality of clusters. The differences may be the second tier deltas that get stored in the table 302. The second plurality of clusters may be identified by the second tier codes stored in the table 304.

In step 606, the artificial intelligence system 108 stores in a first table 306 an identifier and a centroid value for each cluster of the second plurality of clusters. The identifiers may be the second tier codes that identify the clusters and the centroid values may be the averages of the second tier deltas assigned to those clusters. In step 608, the artificial intelligence system 108 stores in a second table 304 an identifier of a respective cluster of the second plurality of clusters corresponding to the weight for each weight of the plurality of weights. These identifiers may be the second tier codes that identify the clusters.

The artificial intelligence system 108 receives a request 120 to apply a first weight 116 in step 610. The request 120 may request that the machine learning model 114 or the artificial intelligence system 108 make a prediction 124 by applying a particular weight 116. In some embodiments, the artificial intelligence system 108 may determine which weight 116 to apply based on the information provided in the request 120. In step 612, the artificial intelligence system 108 determines an estimated weight 122. As discussed in previous examples, the artificial intelligence system 108 may determine the estimated weight 122 by summing the centroid values of the various tiers of clusters corresponding to the requested weight 116. In step 614, the artificial intelligence system 108 makes a prediction 124 using the estimated weight 122. In certain embodiments, the more tiers 118 that the artificial intelligence system 108 stores, loads, or processes to generate the estimated the weights 122, the more accurate the prediction 124 is.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method comprising:
clustering a plurality of weights of a neural network model into a first plurality of clusters;
clustering differences between (i) the plurality of weights assigned to a first cluster of the first plurality of clusters and (ii) a centroid value of the first cluster into a second plurality of clusters;
storing, in a first table, an identifier and a centroid value for each cluster of the second plurality of clusters; and
for each of the plurality of weights assigned to the first cluster, storing, in a second table, an identifier of a respective cluster of the second plurality of clusters corresponding to that weight.

2. The method of claim 1, further comprising:
receiving a request to apply a first weight of the plurality of weights in making a prediction;
in response to the request:
determining that the first weight is assigned to the first cluster and, based on the second table, that the first weight corresponds to a second cluster of the second plurality of clusters;
in response to determining that the first weight is assigned to the first cluster and that the first weight corresponds to the second cluster, adding the centroid value of the first cluster to a centroid value of the second cluster to produce an estimated weight; and
making the prediction, using the neural network model, by applying the estimated weight.

3. The method of claim 1, wherein the centroid value for each cluster of the second plurality of clusters is an average of differences between the plurality of weights assigned to that cluster of the second plurality of clusters and the centroid value of the first cluster.

4. The method of claim 1, further comprising:
storing, in a third table, an identifier and a centroid value for each cluster of the first plurality of clusters, wherein the centroid value for each cluster of the first plurality of clusters is an average of the plurality of weights assigned to that cluster; and
for each of the plurality of weights, storing, in a fourth table, an identifier of a cluster of the first plurality of clusters in which that weight is assigned.

5. The method of claim 4, further comprising:
receiving a request to load the neural network model; and
in response to the request and based on an amount of available memory, loading either the third and fourth tables or the first, second, third, and fourth tables.

6. The method of claim 4, further comprising:
loading the third and fourth tables;
receiving a request to improve an accuracy of the neural network model; and
in response to the request, loading the first and second tables.

7. The method of claim 1, further comprising, for a second cluster of the second plurality of clusters:
clustering differences between (i) the differences between the plurality of weights assigned to the first cluster and the centroid value of the first cluster and (ii) a centroid value of the second cluster into a third plurality of clusters; and
storing, in a third table, an identifier and a centroid value for each cluster of the third plurality of clusters.

8. An apparatus comprising:
a memory; and
a hardware processor communicatively coupled to the memory, the hardware processor configured to:
cluster a plurality of weights of a neural network model into a first plurality of clusters;
cluster differences between (i) the plurality of weights assigned to a first cluster of the first plurality of clusters and (ii) a centroid value of the first cluster into a second plurality of clusters;
store, in a first table, an identifier and a centroid value for each cluster of the second plurality of clusters; and
for each of the plurality of weights assigned to the first cluster, store, in a second table, an identifier of a respective cluster of the second plurality of clusters corresponding to that weight.

9. The apparatus of claim 8, the hardware processor further configured to:
receive a request to apply a first weight of the plurality of weights in making a prediction;
in response to the request:
determine that the first weight is assigned to the first cluster and, based on the second table, that the first weight corresponds to a second cluster of the second plurality of clusters;
in response to determining that the first weight is assigned to the first cluster and that the first weight corresponds to the second cluster, add the centroid value of the first cluster to a centroid value of the second cluster to produce an estimated weight; and
make the prediction, using the neural network model, by applying the estimated weight.

10. The apparatus of claim 8, wherein the centroid value for each cluster of the second plurality of clusters is an average of differences between the plurality of weights assigned to that cluster of the second plurality of clusters and the centroid value of the first cluster.

11. The apparatus of claim 8, the hardware processor further configured to:
store, in a third table, an identifier and a centroid value for each cluster of the first plurality of clusters, wherein the centroid value for each cluster of the first plurality of clusters is an average of the plurality of weights assigned to that cluster; and
for each of the plurality of weights, store, in a fourth table, an identifier of a cluster of the first plurality of clusters in which that weight is assigned.

12. The apparatus of claim 11, the hardware processor further configured to:
receive a request to load the neural network model; and
in response to the request and based on an amount of available memory, load either the third and fourth tables or the first, second, third, and fourth tables.

13. The apparatus of claim 11, the hardware processor further configured to:
load the third and fourth tables;
receive a request to improve an accuracy of the neural network model; and
in response to the request, load the first and second tables.

14. The apparatus of claim 8, the hardware processor further configured to, for a second cluster of the second plurality of clusters:
cluster differences between (i) the differences between the plurality of weights assigned to the first cluster and the centroid value of the first cluster and (ii) a centroid value of the second cluster into a third plurality of clusters; and
store, in a third table, an identifier and a centroid value for each cluster of the third plurality of clusters.

15. A method comprising:
clustering a plurality of weights of a neural network model into a first plurality of clusters, the plurality of weights comprising a first weight;
clustering differences between (i) the plurality of weights assigned to a first cluster of the first plurality of clusters and (ii) a centroid value of the first cluster into a second plurality of clusters;
storing, in a first table, an identifier and a centroid value for each cluster of the second plurality of clusters;
for each of the plurality of weights assigned to the first cluster, storing, in a second table, an identifier of a respective cluster of the second plurality of clusters corresponding to that weight;
determining that the first weight is assigned to the first cluster and, based on the second table, that the first weight corresponds to a second cluster of the second plurality of clusters;
in response to determining that the first weight is assigned to the first cluster and that the first weight corresponds to the second cluster, adding the centroid value of the first cluster to a centroid value of the second cluster to produce an estimated weight; and
making a prediction, using the neural network model, by applying the estimated weight.

16. The method of claim 15, wherein the centroid value for each cluster of the second plurality of clusters is an average of differences between the plurality of weights assigned to that cluster of the second plurality of clusters and the centroid value of the first cluster.

17. The method of claim 15, further comprising:
storing, in a third table, an identifier and a centroid value for each cluster of the first plurality of clusters, wherein the centroid value for each cluster of the first plurality of clusters is an average of the plurality of weights assigned to that cluster; and
for each of the plurality of weights, storing, in a fourth table, an identifier of a cluster of the first plurality of clusters in which that weight is assigned.

18. The method of claim 17, further comprising:
receiving a request to load the neural network model; and
in response to the request and based on an amount of available memory, loading either the third and fourth tables or the first, second, third, and fourth tables.

19. The method of claim 17, further comprising:
loading the third and fourth tables;
receiving a request to improve an accuracy of the neural network model; and
in response to the request, loading the first and second tables.

20. The method of claim 15, further comprising, for a second cluster of the second plurality of clusters:
clustering differences between (i) the differences between the plurality of weights assigned to the first cluster and the centroid value of the first cluster and (ii) a centroid value of the second cluster into a third plurality of clusters; and
storing, in a third table, an identifier and a centroid value for each cluster of the third plurality of clusters.
